(19) United States
(12) Patent Application Publication
(10) Pub. No.: US 2010/0302445 A1
(43) Pub. Date: Dec. 2, 2010

(54) INFORMATION DISPLAY DEVICE, INFORMATION DISPLAY METHOD, AND INFORMATION DISPLAY PROGRAM PRODUCT

(76) Inventor: Shinji KUNIHARA, Kanagawa (JP)

Correspondence Address: FROMMER LAWRENCE & HAUG LLP, 745 FIFTH AVENUE, NEW YORK, NY, 10151, US

(21) Appl. No.: 12/783,901

(22) Filed: May 20, 2010

(30) Foreign Application Priority Data
May 27, 2009 (JP) P2009-127125

(51) Int. Cl. H04N 11/00

(52) U.S. Cl. 348/569; 348/E11.001

(57) ABSTRACT

An information display device includes a video display section displaying video information, an audio information acquisition section acquiring audio information synchronized with the video information, a color determination section determining a color in response to a volume of the audio information acquired by the audio information acquisition section, and a volume display control section displaying an inside of a volume level display region set to a part of a video display region of the video display section in the color determined by the color determination section.

### BACKGROUND OF THE INVENTION

1. Field of the Invention

The present invention relates to an information display device, an information display method, and an information display program product, and more particularly to an information display device, an information display method, and an information display program product that display a volume level along with video information.

2. Description of the Related Art

When a video is displayed, an audio level meter is used to identify the volume level in synchronization with the video in the related art. That is, the audio level meter is a meter to be used at the time of identifying a level of an input or output audio. When the actual audio has a plurality of channels, it is difficult to simultaneously discriminate the plurality of channels. However, it is possible to simultaneously visually identify audio states of the plurality of channels using the audio level meter. Thus, the audio level meter is widely used in the control room of a video production department.

As this audio level meter, rod-shaped display having a lighting section to expand or contract in response to the level is used or a lighting section of rod-shaped display to be colored and displayed in response to the volume level is used (for example, see Japanese Unexamined Patent Application Publication No. 61-253689 and Japanese Unexamined Utility Model Registration Application Publication Nos. 54-127526 and 60-127564).

### SUMMARY OF THE INVENTION

However, in the related art, the rod-shaped display having the lighting section to expand and contract in response to the level is provided as the audio level meter, which may impede the video display. In particular, the ratio occupied by the display of the audio level meter during the video display is increased when the number of channels of audio information is increased, and a problem that the primary video display is difficult to be viewed becomes noticeable.

It is desirable to provide a technique of accurately displaying a volume level without impeding video display.

According to an embodiment of the present invention, there is a provided an information display device including a video display section displaying video information, an audio information acquisition section acquiring audio information synchronized with the video information, a color determination section determining a color in response to a volume of the audio information acquired by the audio information acquisition section, and a volume display control section displaying an inside of a volume level display region set to a part of a video display region of the video display section in the color determined by the color determination section.

In this embodiment of the present invention, it is possible to view the volume level by a color within one volume level display region without display expansion and contraction corresponding to the volume level since the display color within the volume level display region is changed in response to the volume.

For example, a very small display area which does not impede video display is set as the volume level display region. For example, a simple small rectangular or circular shape is set and the total color within the shape is changed with the volume level. When there is multi-channel audio information, the volume level display region associated with each channel is displayed. Since the volume level display region is formed in a simple shape, video display is not impeded even in multiple channels.

The volume display control section sets an outer peripheral frame of the volume level display region, and changes and displays the color of the outer peripheral frame when the volume of audio information has exceeded a preset level, or changes the display type of the outer peripheral frame by whether or not the volume of the audio information is at a level of 0.

According to another embodiment of the present invention, there is provided an information display method including the steps of acquiring video information and audio information synchronized with the video information, determining a color in response to a volume of the audio information, setting a volume level display region to a part of a video display region of a video display section when the video information is displayed on the video display section, and displaying an inside of the volume level display region in the color determined in response to the volume of the audio information.

In this embodiment of the present invention, it is possible to view the volume level by a color within one volume level display region without display expansion and contraction corresponding to the volume level since a display color within the volume level display region is changed in response to the volume.

According to a further embodiment of the present invention, there is provided an information display program product for causing a computer to execute the steps of acquiring video information and audio information synchronized with the video information, determining a color in response to a volume of the audio information, setting a volume level display region to a part of a video display region of a video display section when the video information is displayed on the video display section, and displaying an inside of the volume level display region in the color determined in response to the volume of the audio information.

In this embodiment of the present invention, the display color within the volume level display region is changed in response to the volume when the volume level is displayed along with video display by a computer. Thus, it is possible to view the volume level by the color within one volume level display region without display expansion and contraction corresponding to the volume level.

According to the embodiments of the present invention, it is possible to accurately display a volume level without impeding video display when a volume level is displayed along with the display of video information.

### BRIEF DESCRIPTION OF THE DRAWINGS

FIG. 1 is a block configuration diagram illustrating an information display device according to this embodiment.

FIG. 2 is a diagram showing an example of the external configuration of the information display device according to this embodiment.

FIG. 3 is a diagram illustrating the flow of an information display method according to this embodiment.

FIG. 4 is a diagram illustrating an example of displaying a volume level display region.

FIGS. 5A to 5D are diagrams illustrating an example of a shape of the volume level display region.

FIG. 6 is a diagram illustrating an example of a color determination table.

FIG. 7 is a diagram showing an example of displaying a color corresponding to a volume level.

FIG. 8 is a diagram illustrating an example of setting a shade of color within the same volume level.

FIGS. 9A to 9C are diagrams illustrating an example of displaying an outer peripheral frame of a volume level display region.

FIG. 10 is a flowchart illustrating a process of determining a type of outer peripheral frame display.

FIG. 11 is a diagram showing a display example when multi-channel audio information has been acquired.

FIG. 12 is a flowchart illustrating an information display program product according to this embodiment.

### DESCRIPTION OF THE PREFERRED EMBODIMENTS

Hereinafter, embodiments of the present invention will be described.

Description will be given in the following sequence.

1. Information display device (an example of the block configuration of the information display device and an example of the external configuration of the information display device)

2. Information display method (a flow of the information display method, an example of volume level display, and an example of a shape of a volume level display region)

3. Specific example of processing by a color determination section (an example of a color determination table, an example of displaying a color corresponding to the volume level, and an example of displaying a color within the same level)

4. Processing by a volume display control section (an example of displaying an outer peripheral frame and an example of a process of determining the type of outer peripheral frame display)

5. Multi-channel display example

6. Information display program product

<1. Information Display Device>

[Block Configuration of Information Display Device]

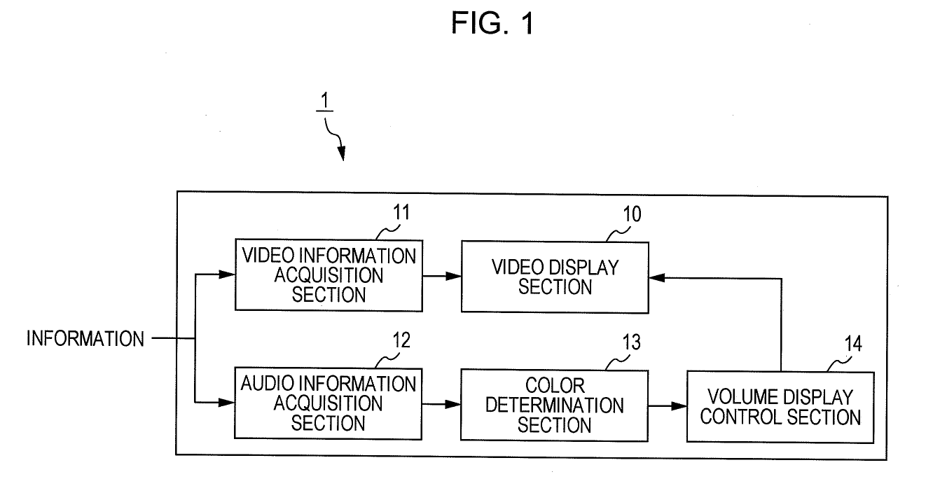

FIG. 1 is a block configuration diagram illustrating the information display device according to this embodiment. That is, an information display device 1 according to this embodiment includes a video display section 10, a video information acquisition section 11, an audio information acquisition section 12, a color determination section 13, and a volume display control section 14.

The video display section 10 is a monitor part which displays video information. The video information acquisition section 11 is a part which acquires video information from received information. Information to be received corresponds to various types. There is a type in which video information and audio information are separately sent or a type in which video information and audio information are sent in a combined state. Information may be sent in a compressed (encoded) state. The video information acquisition section 11 executes a process of extracting video information by decompression (decoding) when information is compressed.

The audio information acquisition section 12 is a part which acquires audio information from received information. As described above, information is received in a type in which video information and audio information are separately sent, a type in which video information and audio information are sent in a combined state, or a type in which information is compressed. The audio information acquisition section 12 executes a process of extracting audio information by decompression (decoding) when information is compressed.

The color determination section 13 executes a process of determining the color corresponding to the volume of the audio information acquired by the audio information acquisition section 12. Details will be described later, but the color determination section 13 determines the color corresponding to the division of the preset volume level in response to the volume of the audio information.

The volume display control section 14 controls a process of setting the volume level display region to a part of the video display region of the video display section 10 and displaying the inside of the set volume level display region in the color determined by the color determination section 13. The volume level display region becomes a very small region to the video display region of the video display section 10. For example, the volume level display region is displayed outside a safe title area of the video display region (a region of 80% to 90% of the center of the video display region). Video display is not impeded even though the volume level display region is displayed.

For example, the video display region has a rectangular shape. The volume level is indicated by colors or display types of the outer peripheral frame and the inner region of the rectangular shape. That is, the color of the inner region of the rectangular shape is displayed by the color determined by the color determination section 13. That is, it is possible to determine the volume level by the color since the color within the inner region of the rectangular shape is changed in response to the volume level of the audio information.

The outer peripheral frame of the rectangular shape indicates a volume level state by a display color or type. For example, when a volume of the audio information has exceeded a preset level, the display color of the outer peripheral frame is displayed to be different from before. For example, when the volume of the audio information has been at a level of 0 (mute), the display type of the outer peripheral frame is displayed to be different from before.

When the audio information acquisition section 12 has acquired multi-channel audio information, the volume display control section 14 sets a plurality of volume level display regions corresponding to a plurality of channels. The color determination section 13 determines the color corresponding to the volume for the audio information of each channel. The volume display control section 14 displays an inside of a volume level display region set for each channel in the color determined by the color determination section 13.

Here, when the volume level display regions corresponding to the plurality of channels are displayed on the video display section 10, the volume display control section 14 displays a channel number corresponding to the volume level display region in the vicinity of the volume level display region set for each channel. Thus, it is possible to determine which volume level display region corresponds to which channel even when a plurality of volume level display regions is displayed.

When there is a history where the volume of audio information has exceeded a preset level within a previously preset time, the volume display control section 14 displays an indication thereof in the volume level display region. For example, when a highest audio level is set and a part in which the audio level of a reproduced video exceeds the highest level exists, the color of an outer peripheral frame of the volume level display region corresponding to the audio channel thereof is changed. Specifically, for example, the outer peripheral frame is changed to the color red when audio information has exceeded the highest level in the volume level display region where the outer peripheral frame is generally in the white color. A state in which the color of the outer peripheral frame has been changed is kept as a predetermined time history. Thus, it is possible to determine whether audio information exceeding the highest level has been previously input by the color of the outer peripheral frame.

In a display control operation by the volume display control section 14, the color or display type of the outer peripheral frame or inside of the volume level display region can be set and changed in response to user preference. The color setting of the outer peripheral frame or inside of the volume level display region is implemented by rewriting content of table data to be used when the color determination section 13 determines a color in response to the volume level. This rewrite operation is performed via a predetermined user interface screen or is performed by downloading the table data via a network. Thus, the association of a color with a volume level or the association of a display type of the outer peripheral frame is set.

[External Configuration of Information Display Device]

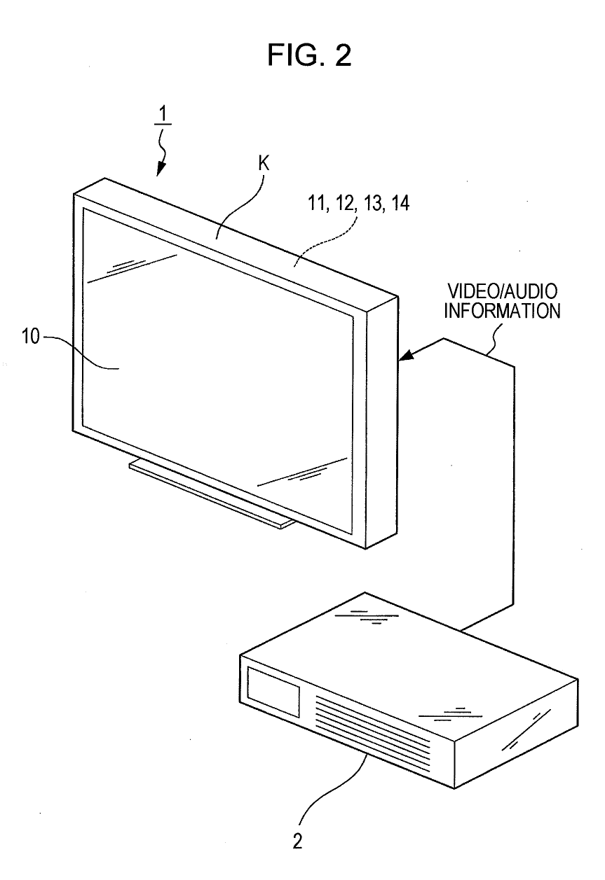

FIG. 2 is a diagram showing an example of the external configuration of the information display device according to this embodiment. In this configuration example, each element of the information display device 1 of this embodiment is embedded into a housing K. The video display section 10 including a monitor of liquid crystal or the like is mounted on the front side of the housing K, and the video information acquisition section 11, the audio information acquisition section 12, the color determination section 13, and the volume display control section 14 described above are mounted inside the housing K. Video/audio information is transmitted from an external video/audio information reproducing device 2 to the information display device 1 via a cable or the like.

The information display device 1 receives video/audio information from the video/audio information reproducing device 2, acquires the video information by the video information acquisition section 11 from the video/audio information, and acquires the audio information by the audio information acquisition section 12. The acquired video information is displayed on the video display section 10 as the monitor of liquid crystal or the like. The acquired audio information is output from a speaker (not shown). Along with audio output, the color determination section 13 determines the color corresponding to the volume level. A volume level display region is displayed on the video display section 10 under control of the volume display control section 14. In the volume level display region, the color corresponding to the volume level of the audio information determined by the color determination section 13 is displayed.

In the example shown in FIG. 2, an information source is the video/audio information reproducing device 2, but may be a broadcast receiver or a camera which receives video and audio. The information source is separated from the information display device 1, but may be embedded into the information display device 1.

The information display device 1 may be implemented by a dedicated video display device like a monitor, and may also be implemented by a general-purpose device such as a personal computer or a mobile terminal. The video information acquisition section 11, the audio information acquisition section 12, the color determination section 13, and the volume display control section 14 constituting the information display device 1 may be constituted by hardware like a dedicated IC (Integrated Circuit) or software.

<2. Information Display Method>

[Flow of Information Display Method]

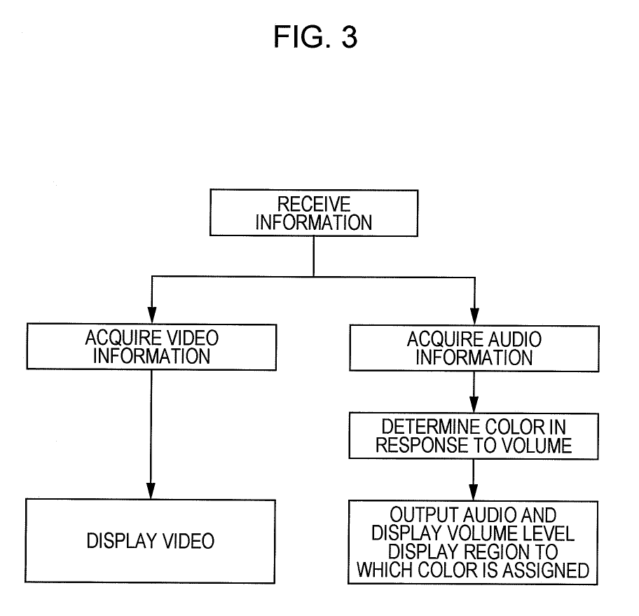

FIG. 3 is a diagram illustrating the flow of an information display method according to this embodiment. First, information is received. Here, the information corresponds to various types. For example, there is a type in which video information and audio information are separately sent or a type in which video information and audio information are sent in a combined state. The information may be sent in a compressed (encoded) state.

Next, video information is acquired from the received information. Audio information is acquired from the received information. That is, when the received information is compressed, a process of decompressing (decoding) the information and extracting video information and audio information synchronized with the video information is executed.

Next, a color corresponding to the volume level is determined from the extracted audio information. The process of displaying the extracted video information on the video display section is executed. When the video information is displayed, a process is executed to output the audio information synchronized with the video information, set the volume level display region indicating the volume level of the audio information, and assign and display the previously determined color inside the volume level display region on the video display section.

[Example of Displaying Volume Level]

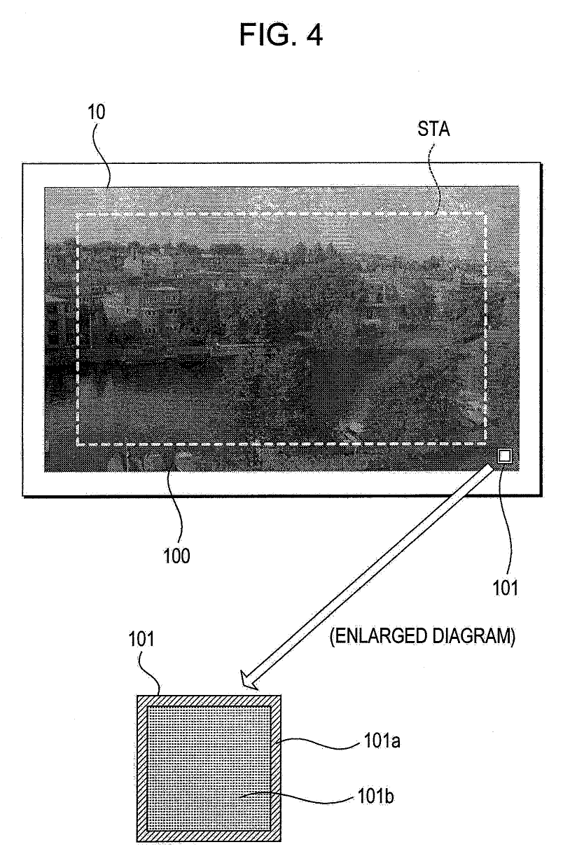

FIG. 4 is a diagram illustrating an example of displaying a volume level display region. In the information display device and the information processing method according to this embodiment described above, video information acquired from received information is displayed on a video display region 100 of the video display section 10. A volume level display region 101 is displayed on a part of the video display region 100. In the example shown in FIG. 4, the volume level display region 101 is set outside the safe title area STA as a region of 80% to 90% of the center of the video display region 100. As shown in the enlarged diagram of FIG. 4, the volume level display region 101 includes an outer peripheral frame 101a and an inside 101b.

The color determined by the color determination section, that is, the color corresponding to the volume level of the audio synchronized with the video currently being reproduced, is assigned to the inside 101b of the volume level display region 101. The size of the volume level display region 101 is constant even when the volume level is changed and the video display is not impeded thereby. Since the color of the inside 101b is changed in response to the volume level in the volume level display region 101, the volume level is identified by referring to the color.

The outer peripheral frame 101a is generally displayed, for example, in white or black, but is changed to a color different from the general color, for example, the display of the color red. In the outer peripheral frame 101a, the display type is changed by the presence or absence of audio information (whether or not the level is 0). For example, when the audio information is absent (0 level), the outer peripheral frame 101a is displayed by the dotted line. When the audio information is present (non-zero level), the outer peripheral frame 101a is displayed by the solid line. When no audio information is present, the inside 101b may be transparent.

In the example shown in FIG. 4, the volume level display region 101 is displayed at the outside or lower right side of the safe title area STA of the video display region 100, but is not limited to this place. That is, when the volume level display region 101 may be displayed at another position outside the safe title area STA or inside the safe title area STA in some cases. That is, it is desirable to display the volume level display region 101 in a size or at a position where video information displayed on the video display region 100 is not impeded.

It is possible for the user to set a display size or position of the volume level display region 101. For example, it is desirable for the volume display control section 14 (see FIG. 1) to control the display by receiving the designation of the user via a user interface and determining a display size or position of the volume level display region 101 on the basis of received setting. The setting may be performed by inputting information regarding the display size or position of the volume level display region 101 to the information display device via a network.

[Example of Shape of Volume Level Display Region]

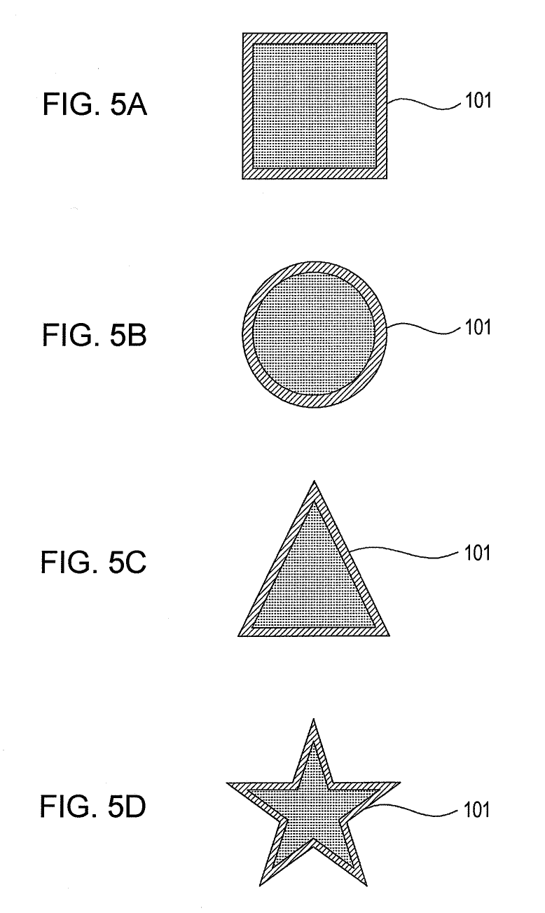

FIGS. 5A to 5D are diagrams illustrating an example of a shape of a volume level display region. FIG. 5A is an example of a rectangular shape, FIG. 5B is an example of a circular shape, FIG. 5C is an example of a triangular shape, and FIG. 5D is an example of a star shape. Any shape is applicable, but a shape capable of being easily viewed by the user in a size where a video displayed in the video display region is not impeded is preferred. In this embodiment, an example of using the volume level display region formed in the rectangular (square) shape will be described hereinafter.

<3. Specific Example of Processing by Color Determination Section>

Next, a specific example of processing by the color determination section will be described.

[Color Determination Table]

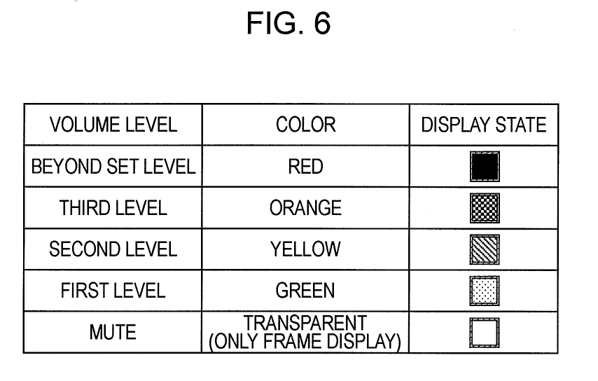

FIG. 6 is a diagram illustrating an example of a color determination table. The color determination section determines a color in response to the volume level of audio information acquired by the audio information acquisition section. When this determination is made, a table in which the correspondence of audio levels and colors shown in FIG. 6 is set is used. In the actual determination process, the determination may be made by a threshold determination process having the same function as the table in addition to the case where the correspondence set as the table is used.

In the example shown in FIG. 6, 5 levels of “Mute”, “First Level”, “Second Level”, “Third Level”, and “Beyond Set Level” as the volume levels are set and associated with colors in response to volume levels. Here, “Mute” is associated with “Transparent (Only Frame Display)”, “First Level” is associated with “Green”, and “Second Level” is associated with “Yellow”. Likewise, “Third Level” is associated with “Orange” and “Beyond Set Level” is associated with “Red”. For example, the highest level may be present as the set level. The color is associated to clearly determine that it has exceeded the highest level. The above-described color setting is exemplary.

The color determination section determines the color corresponding to the volume level using the above-described table. That is, the corresponding volume level is determined from the volume of input audio information, and a color corresponding to the determined volume level is determined by the table. The determined color is output to the volume display control section 14 and is assigned to the volume level display region set by the volume display control section 14 in accordance with the audio information output.

In the above description, the example of setting the 5 levels from “Mute” to “Beyond Set Level” has been shown, but it is desirable to set at least 2 levels other than the 5 levels.

[Example of Displaying Color Corresponding to Volume Level]

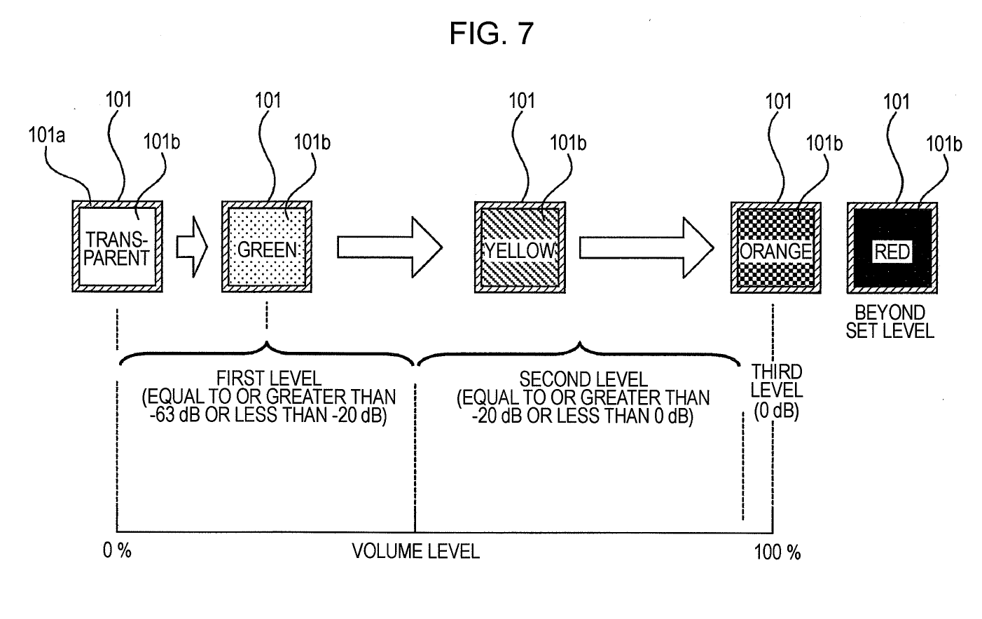

FIG. 7 is a diagram showing an example of displaying a color corresponding to the volume level. This display example corresponds to the table shown in FIG. 6. FIG. 7 shows a color change of the volume level display region 101 corresponding to the volume level. That is, it shows the form in which the color of one volume level display region is changed with the volume level.

When the volume level is a level of 0 (mute), only the outer peripheral frame 101a is displayed and the inside 101b is displayed to be transparent. When the volume level is the first level (for example, equal to or greater than −63 dB or less than −20 dB), the inside 101b is displayed in the color green. When the volume level is the second level (for example, equal to or greater than −20 dB or less than 0 dB), the inside 101b is displayed in the yellow color. When the volume level is the third level (for example, 0 dB), the inside 101b is displayed in the color orange. When the volume level has exceeded the set level, the inside 101b is displayed in the color red.

[Example of Displaying Color Within Same Level]

The color determination section 13 may make a determination to change the shade of color in response to the volume level even within the same level, besides an example of determining a color corresponding to the volume level as shown in FIGS. 6 and 7. For example, when the level range is set like the first level and the second level shown in FIGS. 6 and 7, the determination of the color corresponding to the level may be made and the shade of color corresponding to the volume within the same level may be set.

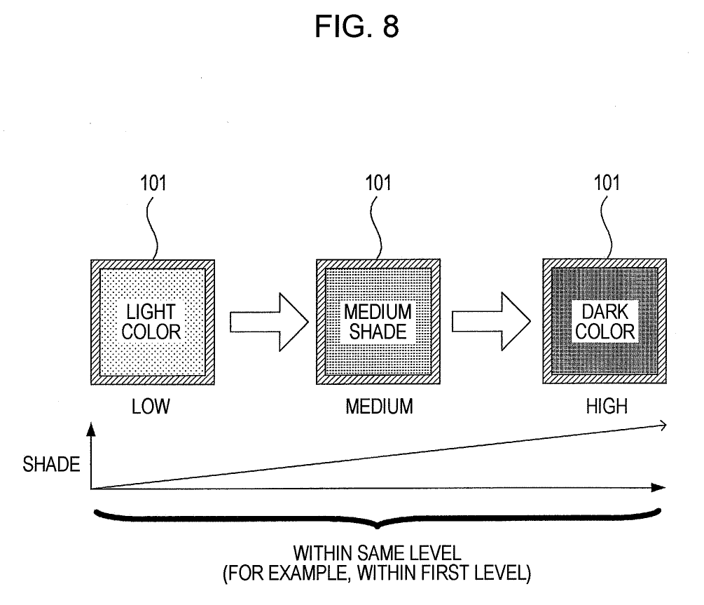

FIG. 8 is a diagram illustrating an example of setting a shade of color within the same volume level. The example of FIG. 8 is the first level, but another range such as that of the second level is equally applicable. For example, setting corresponding to the case where a volume is equal to or greater than −63 dB or less than −20 dB is made at the first level. In this case, the color determination section 13 (see FIG. 1) determines that the color is green from the table shown in FIG. 6. Furthermore, the color determination section 13 determines a shade of green in response to the volume level within a range of the first level even in the same green color.

For example, the color green is set to be dark when the volume of the first level is changed from the low side to the high side. Specifically, the minimum of the volume range of the first level is set to 0% and the maximum is set to 100%. The shade range is set in which the shade of green is the lightest color at 0% and is the darkest color at 100%. The magnitude (%) of the volume range of the first level of an input volume is distributed in proportion to the shade range, and the shade of green is determined by the input volume. The color determination section 13 notifies the volume display control section 14 of the shade along with the determined color. The volume display control section 14 controls the color to be assigned to the volume level display region 101 by the color and the shade reported from the color determination section 13.

Thus, as shown in FIG. 8, even in the volume included at the same level (for example, the first level), the color is changed to a light green at a low volume level, the color is changed to a medium green at a medium volume level, and the color is changed to a dark green at a high volume level. When the shade of color is changed with the volume within the level even in the same color by the same level, it is possible to view the degree of volume within the same level.

<4. Processing by Volume Display Control Section>

[Display Example of Outer Peripheral Frame>

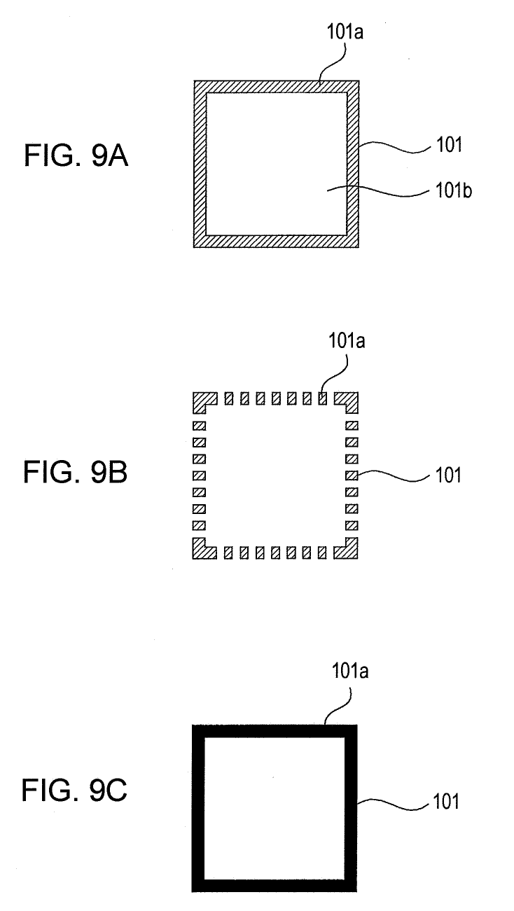

FIGS. 9A to 9C are diagrams illustrating an example of displaying an outer peripheral frame of a volume level display region. In this embodiment, a shape change as well as a color change is set as the display type of the outer peripheral frame 101a of the volume level display region 101. The display type of the outer peripheral frame is mainly made by the volume display control section 14 (see FIG. 1), but the color determination may be made by the color determination section 13 (see FIG. 1).

In the example shown in FIG. 9A, the outer peripheral frame 101a of the volume level display region 101 is displayed by the solid line. For example, when the volume level of the input audio information is not a level of 0 (mute), the outer peripheral frame 101a is displayed by the solid line. At this time, for example, the color uses the color white or black or the same color as in the inside 101b. The volume display control section 14 (see FIG. 1) controls the outer peripheral frame 101a to be displayed by the solid line when the outer peripheral frame 101a of the volume level display region 101 is displayed in the case where the volume level is not the level of 0 (mute), and causes the video display section 10 to display the outer peripheral frame 101a.

In the example shown in FIG. 9B, the outer peripheral frame 101a of the volume level display region 101 is displayed by the dotted line. For example, when the volume level of the input audio information has been the level of 0 (mute), the outer peripheral frame 101a is displayed by the dotted line. At this time, for example, the color uses the color white or black. The volume display control section 14 (see FIG. 1) controls the outer peripheral frame 101a to be displayed by the dotted line when the outer peripheral frame 101a of the volume level display region 101 is displayed in the case where the volume level has been the level of 0 (mute), and causes the video display section 10 to display the outer peripheral frame 101a.

In the example shown in FIG. 9C, the outer peripheral frame 101a of the volume level display region 101 is displayed by the solid line and is displayed in a color different from the color shown in FIG. 9A. For example, when the volume level of the input audio information has exceeded a preset level, the outer peripheral frame 101a is displayed by the solid line and is displayed in a color different from that when the volume level has not exceeded the preset level. At this time, for example, the color uses the color red. The volume display control section 14 (see FIG. 1) controls the outer peripheral frame 101a to be displayed by the solid line when the outer peripheral frame 101a of the volume level display region 101 is displayed in the case where the volume level has exceeded the preset level (for example, the highest level), controls a color, for example, the color red, different from that at the general level to be displayed, and causes the video display section 10 to display the outer peripheral frame 101a. The color determination may also be made by the color determination section 13 (see FIG. 1).

[Process of Determining Display Type of Outer Peripheral Frame]

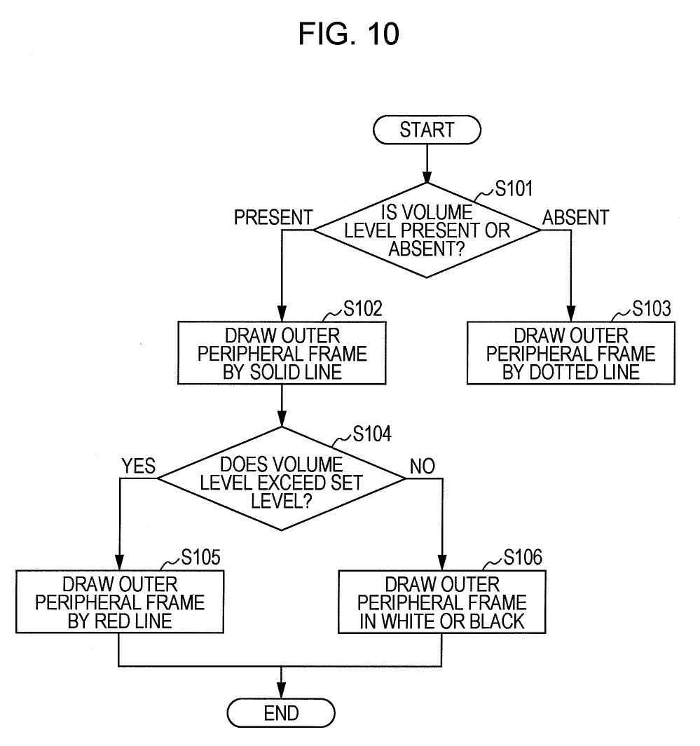

FIG. 10 is a flowchart illustrating a process of determining a display type of an outer peripheral frame. The flowchart may be executed by the volume display control section 14 shown in FIG. 1 and by the color determination section 13 as necessary.

First, it is determined whether or not a volume level of audio information is present (step S101). When the volume level is present, the outer peripheral frame is drawn by the solid line (step S102). On the other hand, when no volume level is present, the outer peripheral frame is drawn by the dotted line (step S103).

Next, when the volume level is present, it is determined whether or not the volume level exceeds a preset level (step S104). When the volume level exceeds the preset level, the outer peripheral frame is drawn by the red line (step S105). On the other hand, when the volume level does not exceed the preset level, the outer peripheral frame is drawn in white or black (step S106).

A simple display shape such as a rectangular shape or the like can be displayed by displaying the volume level display region, and the volume level can be recognized in a color. The state of audio information can also be identified by the outer peripheral frame.

<5. Multi-Channel Display Example>

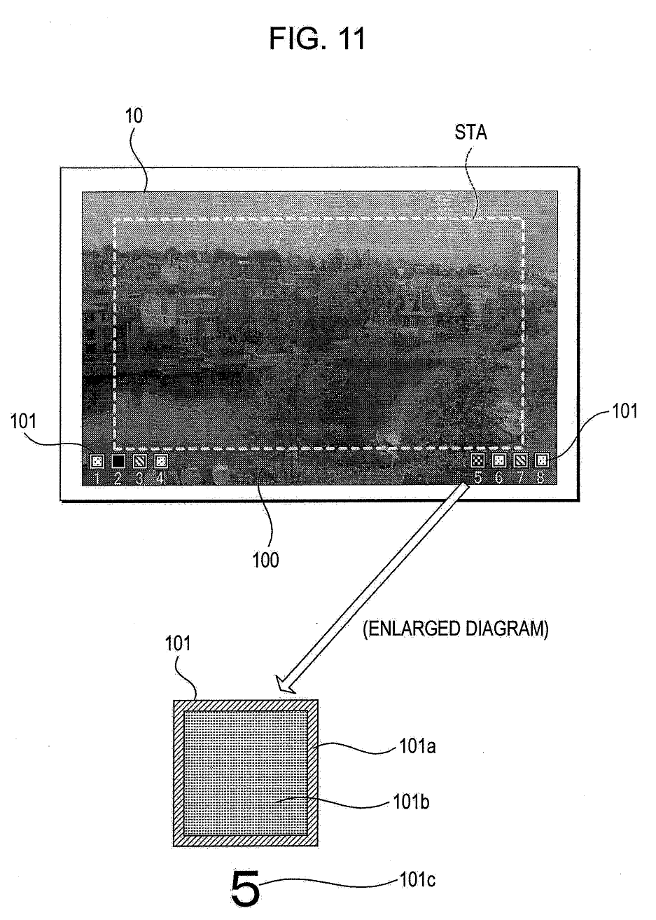

Next, the display example in the case where multi-channel audio information has been acquired when the audio information has been acquired by the audio information acquisition section 12 (see FIG. 1) will be described. FIG. 11 is a diagram showing a display example in the case where the multi-channel audio information has been acquired.

When the audio information acquisition section 12 has acquired multi-channel audio information, the color determination section 13 (see FIG. 1) determines the color corresponding to the volume for the audio information of each channel. The volume display control section 14 (see FIG. 1) controls the process of setting the volume level display region for each channel and displaying each volume level display region having an inside to which the color corresponding to the volume of each channel determined by the color determination section is assigned.

In the example shown in FIG. 11, volume level display regions 101 corresponding to 8-channel audio information are displayed. That is, the 8 volume level display regions 101 corresponding to the channels are displayed on a part of the video display region 100 of the video display section 10. Here, 4 volume level display regions 101 are arranged and displayed at each of the lower left and right sides outside the safe title area STA of the video display region 100.

When multi-channel audio information is present, a corresponding channel number is displayed in the vicinity of the volume level display region 101 corresponding to each channel. In the example shown in FIG. 11, 4 volume level display regions 101 corresponding to first to fourth channels are displayed at the lower left side outside the safe title area STA, and channel numbers 1 to 4 are displayed in the vicinity of the lower side of the volume level display regions 101. Further, 4 volume level display regions 101 corresponding to fifth to eighth channels are displayed at the lower right side outside the safe title area STA, and channel numbers 5 to 8 are displayed in the vicinity of the lower side of the volume level display regions 101.

In the enlarged diagram of FIG. 11, the display example of the volume level display region 101 corresponding to the fifth channel is displayed. One volume level display region 101 corresponds to one channel and a corresponding channel number 101c is indicated by a numeral in the vicinity (for example, the lower side) of the volume level display region 101. The volume level display region 101 includes the outer peripheral frame 101a and the inside 101b. This display type is the same as described above. The display of the volume level display region 101 and the channel number 101c is controlled by the audio display control section 14.

Thus, it possible to determine which volume level display region 101 corresponds to which channel and accurately determine the volume level of each channel without impeding video display even when multi-channel audio information is input.

The display size or position of the volume level display region 101 is not limited to the above-described example. For example, these may be set by the user. Specifically, it is desirable for the volume display control section 14 (see FIG. 1) to control display by receiving the designation of the user via a user interface and determining the display size or position of the volume level display region 101 on the basis of received setting. The setting may be performed by inputting information regarding the display size or position of the volume level display region 101 to the information display device via a network.

<6. Information Display Program Product>

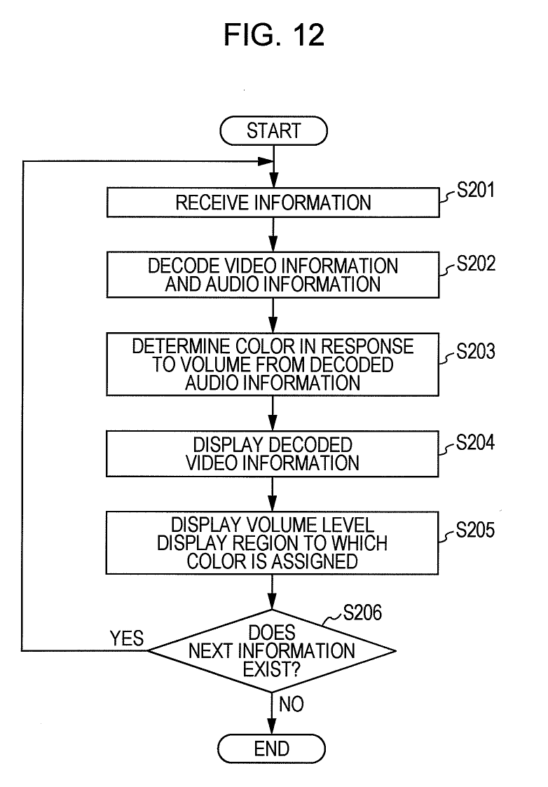

FIG. 12 is a flowchart illustrating an information display program product according to this embodiment. The information display program according to this embodiment has the steps to be executed by a computer. The computer is provided with a computation section which executes the information processing program product according to this embodiment, a storage section which stores the program product or various data, and an input/output section. The computer may be embedded into a video recording/reproducing device or an electronic device capable of handling information of a mobile terminal or the like as well as an electronic computer such as a personal computer. The information processing program product of this embodiment may be recorded to a recording medium such as a CD-ROM or may be distributed via a network.

First, information is received (step S201). The information has various types and reception corresponding to various types is performed. For example, there is a type in which video information and audio information are separately sent or a type in which video information and audio information are sent in a combined state. Information may be sent in a compressed (encoded) state. For example, the information is received in a unit of a data amount corresponding to 1 frame of a video.

Next, video information is acquired from the received information and audio information synchronized with the video information is acquired (step S202). For example, when the information is compressed (encoded), each of the video information and the audio information is decompressed (decoded).

Next, a color corresponding to the volume is determined from the decoded audio information (step S203). The determination of the color corresponding to the volume may be a process of determining the color by the determination of the volume and the threshold of the level boundary as Well as a method using the table shown in FIG. 6.

Next, the decoded video information is displayed on the video display section (step S204). Along with the display of the video information, the audio information synchronized with the video information is output. Along with the display of the video information, the volume level display region to which the color is assigned is displayed (step S205). That is, the volume level display region is set on a part of the video display region, and the volume level display region to which the color corresponding to the volume determined in the above step S203 is assigned is displayed. Thus, the volume level of the audio synchronized with the video currently being displayed is indicated in the color in the volume level display region.

Subsequently, it is determined whether or not the next information is present (step S206). When the information is received in a unit of a data mount corresponding to 1 frame of a video, it is determined whether or not information corresponding to the next 1 frame is present. If so, a subsequent process is repeated by returning to step S201. Otherwise, the process is ended.

In this embodiment, since the volume level is not displayed in a rod shape and is displayed as a color in one simple shape when the volume level is displayed along with video display, the volume level can be displayed without impeding the video. The volume level can be visually identified by the color. Even when multi-audio information is present, the volume level of each channel can be displayed in the color corresponding to each channel without impeding the video. A mute state or a state in which the volume level exceeds a highest level can be displayed in the display type of the outer peripheral frame of the color display of the simple shape.

The present application contains subject matter related to that disclosed in Japanese Priority Patent Application JP 2009-127125 filed in the Japan Patent Office on May 27, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information display device comprising:
a video display section displaying video information;
an audio information acquisition section acquiring audio information synchronized with the video information;
a color determination section determining a color in response to a volume of the audio information acquired by the audio information acquisition section; and
a volume display control section displaying an inside of a volume level display region set to a part of a video display region of the video display section in the color determined by the color determination section.

2. The information display device according to claim 1,
wherein the volume display control section sets an outer peripheral frame of the volume level display region and causes a color of the outer peripheral frame to be changed and displayed when the volume of the audio information has exceeded a preset level.

3. The information display device according to claim 1,
wherein the volume display control section sets an outer peripheral frame of the volume level display region and causes a display type of the outer peripheral frame to be changed by whether or not the volume of the audio information is at a level of 0.

4. The information display device according to claim 1,
wherein when the audio information acquisition section has acquired multi-channel audio information,
the color determination section determines a color corresponding to a volume for audio information of each channel, and
the volume display control section displays an inside of a volume level display region set for each channel in a color corresponding to a volume for each channel determined by the color determination section.

5. The information display device according to claim 1,
wherein when the audio information acquisition section has acquired multi-channel audio information,
the volume display control section displays a channel number corresponding to a volume level display region in the vicinity of the volume level display region set for each channel.

6. The information display device according to claim 1,
wherein when there is a history in which the volume of the audio information has exceeded a preset level in a previously preset time,
the volume display control section displays an indication thereof in the volume level display region.

7. The information display device according to claim 1,
wherein the volume display control section controls the volume level display region to be displayed outside a safe title area of the video display region.

8. An information display method comprising the steps of:
acquiring video information and audio information synchronized with the video information;
determining a color in response to a volume of the audio information; and
setting a volume level display region to a part of a video display region of a video display section when the video information is displayed on the video display section; and
displaying an inside of the volume level display region in the color determined in response to the volume of the audio information.

9. An information display program product for causing a computer to execute the steps of:
acquiring video information and audio information synchronized with the video information;
determining a color in response to a volume of the audio information;
setting a volume level display region to a part of a video display region of a video display section when the video information is displayed on the video display section; and
displaying an inside of the volume level display region in the color determined in response to the volume of the audio information.
